(19) United States
(12) Patent Application Publication
(10) Pub. No.: US 2021/0206093 A1
(43) Pub. Date: Jul. 8, 2021

(54) THREE-DIMENSIONAL (3D) PRINTER MODULES

(71) Applicant: HEWLETT-PACKARD DEVELOPMENT COMPANY, L.P., Sjpring, TX (US)

(72) Inventors: Warren Scott MARTIN, Vancouver, WA (US); Jeffrey A. WAGNER, Vancouver, WA (US); Michael GRAHAM, Vancouver, WA (US)

(73) Assignee: HEWLETT-PACKARD DEVELOPMENT COMPANY, L.P., Houston, TX (US)

(21) Appl. No.: 16/075,683

(22) PCT Filed: Apr. 20, 2017
(86) PCT No.: PCT/US2017/028640

§ 371 Date: Aug. 6, 2018

(51) Int. Cl. B29C 64/35

(52) U.S. Cl. CPC B29C 64/35; B33Y 40/20

(57) ABSTRACT

In some examples, a service module of a three-dimensional (3D) printer can include a housing, a web to clean a print head of the 3D printer, where the web is housed by the housing, and where the service module is removably attached to the 3D printer, and a shield to shield the web.

### BACKGROUND

A three dimensional (3D) printer may be used to create different 3D objects. 3D objects created by a 3D printer may be used for various purposes. For example, 3D objects may be used for prototyping, testing, and/or other commercial uses.

In some examples, 3D printers may utilize an additive manufacturing process. For instance, a 3D printer may deposit material in successive layers to create a 3D object. The material can be selectively fused, or otherwise solidified, to form the successive layers of the 3D object.

### BRIEF DESCRIPTION OF THE DRAWINGS

FIG. 1 illustrates a diagram of an example of a service module of a 3D printer consistent with the disclosure.

FIG. 2 illustrates a diagram of an example of a capping gimbal plate module of a 3D printer consistent with the disclosure.

FIG. 3 illustrates an example of a system of 3D printer modules in an exploded view consistent with the disclosure.

FIG. 4 illustrates an example of a capping gimbal plate module removal consistent with the disclosure.

FIG. 5 illustrates an example of a system of 3D printer modules consistent with the disclosure.

### DETAILED DESCRIPTION

A 3D printer may utilize many components when creating a 3D object during a print operation. A 3D printer may apply deposit print media such as a build material, and/or printing agents such as fusing agents, and/or cosmetic agents to the 3D object during the print operation of the 3D object. The components delivering the print media, fusing agents, and/or cosmetic agents may have to be kept clean to ensure efficient and/or proper functioning of the components of the 3D printer. As used here, the term “print operation” can, for example, refer to a process of creating a 3D object and may be performed, for example, by a 3D printer.

As used herein, the term “3D printer” can, for example, refer to a device that can create a physical 3D object. In some examples, the 3D printer can create the 3D object utilizing a 3D digital model. The 3D printer can create the 3D object by, for example, deposit a printing media such as a build material, and a printing agent. The build material and printing agent may be deposited in successive layers to create the 3D object. In some examples, a 3D printer can create the 3D object utilizing powder bed fusion, among other types of 3D printing.

The components delivering build material, printing agents, and/or cosmetic agents may be cleaned. Various components delivering printing agents and/or cosmetic agents may be cleaned by a cleaning media. Eventually, maintenance may have to be performed on the 3D printer, which may include cleaning components of the 3D printer and/or replacing the cleaning media. A trained service technician may have to perform maintenance on the 3D printer, which may be costly and/or lead to the 3D printer being out of service for an extended period of time.

Modules of a 3D printer can provide 3D printer component modularity, which can allow for quick and efficient maintenance of a 3D printer. For example, a user, such as customer or employee with little or no prior training experience with a 3D printer may easily and quickly perform maintenance activities on a printer. Maintenance activities can include cleaning components of the 3D printer, and/or replacing cleaning media of the 3D printer. Modules of a 3D printer can prevent a user from hiring a trained service technician from having to perform maintenance on the 3D printer, reducing 3D printer downtime and cost.

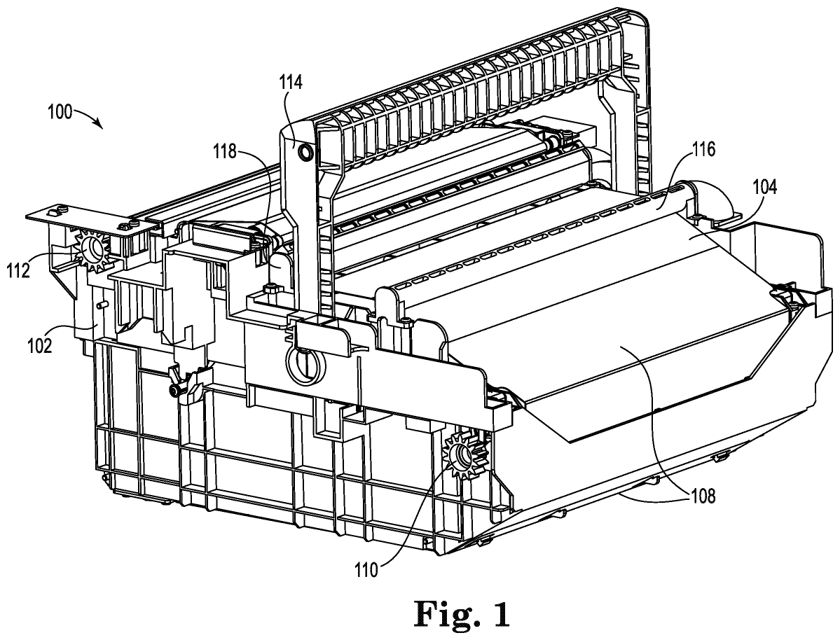

FIG. 1 illustrates a diagram of an example of a service module 100 of a 3D printer consistent with the disclosure. The service module 100 can include a housing 102, a web 104, a shield 108, a web advance drive 110, a spit roller drive 112, a handle 114, and air duct 116, 118.

As shown in FIG. 1, service module 100 can include housing 102. Housing 102 can be a casing that can include various parts and/or mechanisms of service module 100. Housing 102 can serve as a support structure for various parts and/or mechanisms of service module 100. For example, housing 102 can be a support structure for web 104, shield 108, web advance drive 110, spit roller drive 112, handle 114, and/or air duct 116, 118, among other parts and/or mechanisms of service module 100 of a 3D printer.

Service module 100 can include web 104. Web 104 can be housed by housing 102. Web 104 can be used to clean a print head of the 3D printer. As used herein, the term “print head” can, for example, refer to a mechanism included in the 3D printer, where the print head can deposit a printing agent, such as a curing liquid, by, for example, using nozzles. A print bar can be an array of print heads. The printing agent may interact with a print media, such as a build material, to produce various desired material properties for a particular print operation of a 3D printing process. In some examples, the build material can be powder. As used herein, the term “build material” can, for example, refer to a powdered material which may be layered and bound via a printing agent during a print operation of a 3D printing process. The powdered material can be, for example, a powdered semi-crystalline thermoplastic material, a powdered metal material, a powdered plastic material, a powdered composite material, a powdered ceramic material, a powdered glass material, a powdered resin material, and/or a powdered polymer material, among other types of powdered material.

Web 104 can be used to clean a print head (not shown) of the 3D printer. As used herein, the term “web” can, for example, refer to a material used to wipe a print head. Web can be, for example, cotton, foam, microdenier, nonwoven, nylon, and/or polyester, material, among other types of lint-free materials.

Service module 100 can include web advance drive 110. Web advance drive 110 can be housed by housing 102 and can advance web 104 through housing 102 to provide a clean portion of web 104 to clean the print head of the 3D printer during a print operation. For example, web 104 may be advanced through housing 102 such that a clean portion of web 104 is exposed to the print head. The print head may then be moved across the clean portion of web 104 to clean the print head. For example, nozzles of the print head may be wiped across the clean portion of web 104 to remove build material or other particulates from the nozzles of the print head.

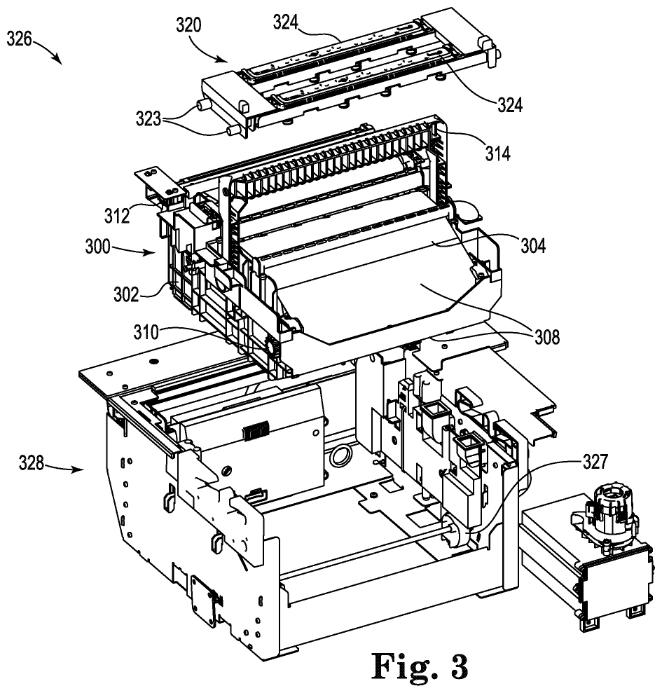

Web advance drive 110 can include a roller connected to a drive gear. The roller can be, for example, a cylinder. The drive gear of web advance drive 110 can be driven by an external power source, causing web advance drive 110 to advance web 104 through housing 102. The external power source can be a part of a service module receiver, as is described in connection with FIG. 3.

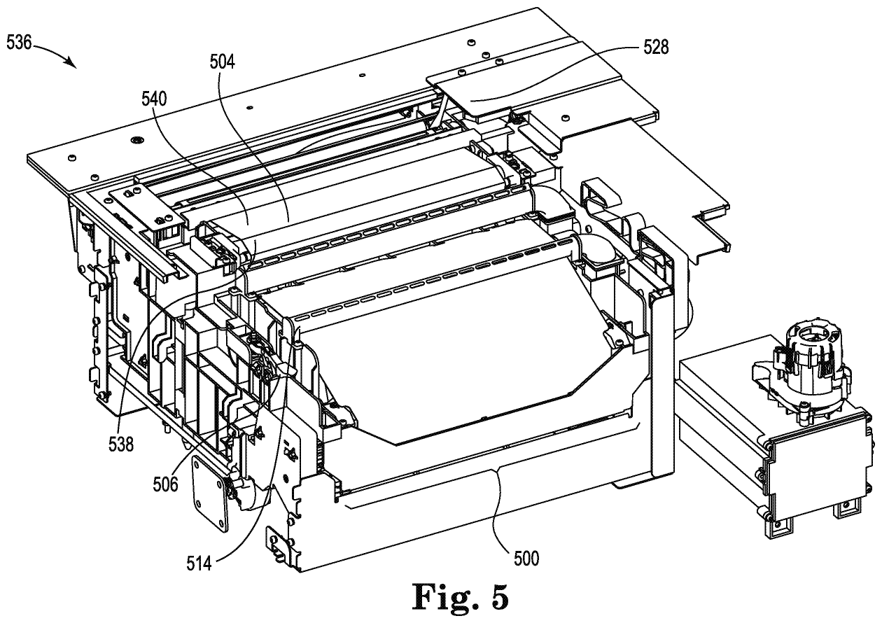

Housing 102 can include a supply roll of web 104 and a take-up roll of web 104, Web advance drive 110 can cause the supply roll of web 104 to be advanced through housing 102 to provide the clean portion (e.g., clean portion 538, discussed in connection with FIG. 5) of web 104 to be exposed to the print head. Following the print head being wiped across the clean portion of web 104, web advance drive 110 can cause a dirty portion (e.g., dirty portion 540, discussed in connection with FIG. 5) of web 104 that has received build material and/or other particulates from the print head to be advanced through housing 102 to be rolled up in the take-up roll. That is, the supply roll of web 104 can be clean web 104 that is exposed to the print head to clean the print head. After the print head has been cleaned by the exposed portion of web 104, dirty web 104 can then rolled into the take-up roll of web 104. Although not shown in FIG. 1 for clarity and so as not to obscure examples of the disclosure, housing 102 can house the supply roll and the take-up roll of web 104, and web 104 can be routed through housing 102.

Housing web 104 in housing 102 can allow for easy replacement of web 104 after the clean supply roll of web 104 has been used to clean the print head. For example, a user can replace service module 100 in response to the clean supply roll of web 104 being used. Housing web 104 in housing 102 can allow for full replacement of service module 100 in response to the clean supply roll of web 104 being used instead of a user having to replace dirty web. For instance, replacing a used web can include removing various components of the 3D printer, feeding new web into a used service module, and through the 3D printer, causing a user and/or the environment around the 3D printer to be exposed to build material and/or other printing agents. That is, replacing a used web can be a dirty process as compared with replacing service module 100. Replacing service module 100 can prevent a user from having to feed new web into a used service module and through the 3D printer, reducing exposure of the user and/or the environment around the 3D printer to build material and/or other printing agents.

In some examples, the print head may become hot during print operations and may have to be cooled. Service module 100 can include air duct 116, 118 to cool the print head. For example, air can be provided to the print head via air duct 116, 118 to cool the print head during print operation if the print head becomes too hot. Air can be provided via air duct 116, 118 using a fan connected to a service module receiver (not shown).

In some examples, service module 100 can include a first air duct 116 to cool a color print head of the 3D printer. For instance, in some examples the 3D printer may utilize a print head to provide a cosmetic agent, such as a coloring agent, to the build material to color a 3D object being printed by the 3D printer. For example, the 3D printer may create a red and black 3D object, and the color print head can selectively provide a red coloring agent to the build material to create the red portions of the 3D object. First air duct 116 can provide air to cool the color print head.

In some examples, service module 100 can include a second air duct 118 to cool a black print head of the 3D printer. For instance, in some examples, the 3D printer may utilize a print head to provide a coloring agent to color build material black to provide the color black to a 3D object being printed by the 3D printer. For example, the 3D printer may create a red and black 3D object, and the black print head can selectively provide a black coloring agent to the build material to create the black portions of the 3D object. Second air duct 118 can provide air to cool the black print head.

Although service module 100 is described as including a first air duct 116 and a second air duct 118 to cool a color print head and a black print head of the 3D printer, respectively, examples of the disclosure are not so limited. For example, service module 100 can include a single air duct, where the single air duct can be used to cool the color print head and the black print head of the 3D printer.

In some examples, air duct 116, 118 may be used to cool a print head providing a cosmetic agent to the build material to create an intended texture. For example, a cosmetic agent may be used to create an intended texture of a 3D object being printed by the 3D printer. Air duct 116, 118 can provide air to cool the print head providing the cosmetic agent used to create the intended texture of the 3D object.

Service module 100 can include a spit roller drive 112. Spit roller drive 112 can be housed by housing 102 and can include a drive gear and a spit roller that can receive a printing media and/or printing agent from the print head during a maintenance job. For instance, in some print operations, a portion of the nozzles of the print head may not be utilized. During some maintenance jobs, the unused nozzles may be maintained by causing the unused nozzles to deposit printing agents from the unused nozzles. As used herein, the term “spit roller” can, for example, refer to a roller such as a cylinder that can receive the deposited printing agents from the unused nozzles. Spit roller drive 112 can be driven by an external power source, causing the spit roller to rotate to cause the printing agents received by the spit roller to be removed from the spit roller. The printing agents removed from the spit roller can be deposited in an absorber matrix (not shown) included in service module 100.

Housing 102 can be removably attached from the 3D printer by a clamp. As used herein, the term “clamp” can, for example, refer to a device to brace, band, attach, or clasp items together. In some examples, the clamp can be included in a service module receiver (e.g., described in connection with FIG. 3) and can attach service module 100 to the 3D printer such that, during operation of the 3D printer (e.g., during a print operation or a maintenance job), service module 100 is mechanically attached to the 3D printer. In some examples, the clamp can be included in housing 102 and can attach service module 100 to the 3D printer. In some examples, the clamp can be a toggle clamp, among other types of clamps.

Service module 100 can be removably attached to the 3D printer via the clamp. For example, the clamp can secure service module 100 to the 3D printer when the clamp is in an engaged position. In some examples, the clamp can be disengaged, allowing service module 100 to be removed from the 3D printer, as is described in connection with FIG. 3. Removing service module 100 can allow cleaning of service module 100, replacement of service module 100, and/or cleaning of the 3D printer.

Service module 100 can include handle 114. Handle 114 can assist in the removal of service module 100 from the 3D printer. For example, handle 114 may be utilized by a user to pull service module 100 from the 3D printer. Handle 114 can allow a user to easily remove service module 100 from the 3D printer without having to grab, for example, housing 102 or other parts of service module 100 to remove service module 100 from the 3D printer.

Service module 100 can include a shield 108. Shield 108 can shield web 104. For example, shield 108 as shown in FIG. 1 can shield a portion of web 104 that has cleaned the print head. As previously described, the portion of web 104 that has cleaned the print head can be dirty web 104 that may be rolled back to the take-up roll of web 104. Although not shown in FIG. 1, the dirty web 104 can be routed from cleaning the print head to the take-up roll adjacent to the shield 108. In some examples, shield 108 can prevent the build material included on the dirty web 104 from being deposited onto a user's clothes or furniture in the event service module 100 is removed from the 3D printer for cleaning or replacement. In some examples, shield 108 can prevent foreign material and/or other items from falling onto web 104, In some examples, shield 108 can prevent foreign material and/or other items that may fall onto web 104 from being fed into web advance drive 110, preventing web advance drive 110 or other parts of the 3D printer from binding or jamming.

Although not shown in FIG. 1 for clarity and so as not to obscure examples of the disclosure, service module 100 can include a shield to shield a portion of web 104 that has not yet cleaned the print head. As previously described, web 104 can be routed from clean supply roll of web 104 to the print head to wipe the print head. This clean web 104 can be shielded to prevent the deposition of build material and/or other particulates that may be airborne outside of service module 100 and/or inside service module 100 prior to clean web 104 wiping the print head.

As described above, service module 100 can include housing 102, web 104, clamp 106, shield 108, web advance drive 110, spit roller drive 112, handle 114, and/or air duct 116, 118, among other parts and/or mechanisms of service module 100 of a 3D printer in a single housing, The single housing 102 can provide modularity to the parts and/or mechanisms included in the service module 100 that are utilized in the 3D printer. Including these parts in service module 100 can allow for a user to easily remove, clean, perform maintenance on, and/or replace the service module 100. The removal and replacement of service module 100 can provide for quick and efficient maintenance and/or replacement, saving on maintenance and/or replacement costs and keeping the 3D printer in a working order without having to schedule a service call.

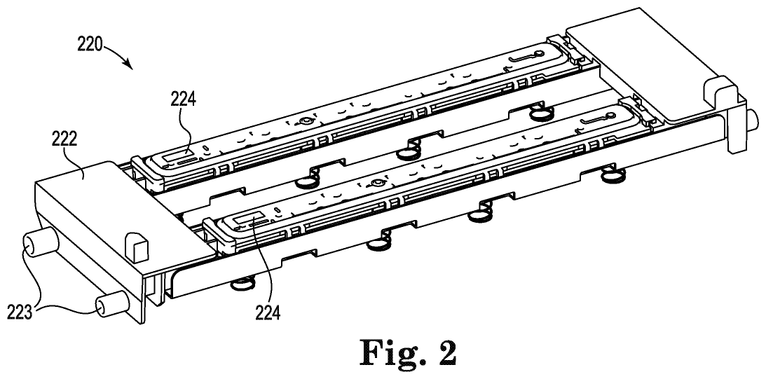

FIG. 2 illustrates a diagram of an example of a capping gimbal plate module 220 of a 3D printer consistent with the disclosure. The capping gimbal plate module 220 can include a plate 222, posts 223, and a cap 224.

Capping gimbal plate module 220 can include a plate 222, Plate 222 can be a plate that can receive cap 224, Plate 222 can include posts 223 that can secure capping gimbal plate module 220 to a service module receiver (e.g., service module receiver 328, as described in connection with FIG. 3).

Capping gimbal plate module 220 can include cap 224. Cap 224 can receive a print head of the 3D printer. For example, when the print head of the 3D printer is not in use, the print head can rest on cap 224.

Cap 224 can include an elastomeric material that can be pressed against the print head. The elastomeric material can, in some examples, seal the nozzles of the print head from the surrounding environment in the 3D printer. For example, the elastomeric material can be pressed against the print head to seal the nozzles of the print head to prevent the nozzles of the print head from drying.

As shown in FIG. 2, capping gimbal plate module 220 can include two caps 224. For example, the 3D printer may include two print heads (e.g., one print head for color, one print head for black). The two caps 224 can be utilized to receive the two print heads. For example, one cap 224 can be utilized to receive the color print head, and the other cap 224 can be utilized to receive the black print head.

Cap 224 can be spring loaded. For example, spring loaded cap 224 can allow the nozzles of the print head to be sealed from the surrounding environment of the 3D printer. Spring loaded cap 224 can provide a better seal of the nozzles of the print head relative to a non-spring loaded cap, as well as provide pressure against the print head to maintain a seal of the print head nozzles during, for example, movement of the 3D printer or vibrations of the 3D printer during a print operation and/or a maintenance job.

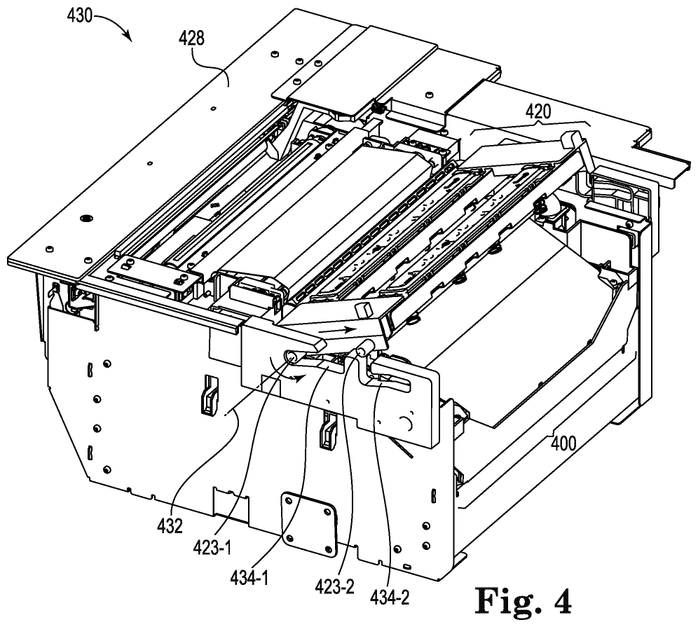

Capping gimbal plate module 220 can be removably attached to the service module receiver via posts 223. For example, the service module receiver can include slots (e.g., slots 434, described in connection with FIG. 4) that can receive posts 223 of capping gimbal plate module 220. Posts 223 can secure capping gimbal plate module 220 to the service module receiver.

Capping gimbal plate module 220 can be removed from the service module receiver, as is further described in connection with FIG. 4. Removing capping gimbal plate module 220 can allow for cleaning of capping gimbal plate module 220.

FIG. 3 illustrates an example of a system 326 of 3D printer modules in an exploded view consistent with the disclosure. The system 326 may include capping gimbal plate module 320, service module 300, and service module receiver 328. Service module 300 can include housing 302, web 304, shield 308, web advance drive 310, spit roller drive 312, and handle 314. Capping gimbal plate module 320 can include cap 324. Service module receiver 328 can include cams 327.

As shown in FIG. 3, capping gimbal plate module 320, service module 300, and service module receiver 328 are shown in an exploded view. That is, capping gimbal plate module 320, service module 300, and service module receiver 328 are shown as being removed from each other. However, both capping gimbal plate module 320 and service module 300 can be attached to service module receiver 328, as is described herein.

System 326 can include service module receiver 328. Service module receiver 328 can be a portion of a 3D printer. Service module receiver 328 can receive the service module 300. Service module receiver 328 can provide an interface for mechanical and/or electrical connections to the 3D printer for service module receiver 328. That is, mechanical and/or electrical connections of service module 300 can be interfaced with the 3D printer via service module receiver 328.

In some examples, an air duct included on service module 300 can be mechanically connected to the 3D printer via a mechanical connection between service module 300 and service module receiver 328. In some examples, web advance drive 310 and/or spit roller drive 312 can be mechanically connected to the 3D printer via a mechanical connection between service module 300 and service module receiver 328, among other mechanical connections.

System 326 can include service module 300. Service module 300 can be removably attached to service module receiver 328. As described in connection with FIG. 1, service module 300 can include a housing 302, a web advance drive 310 with a web 304 housed by housing 302, a spit roller drive 312 with a spit roller housed by housing 302, a shield 308, and a handle 314.

As described in connection with FIG. 1, web 304 can be exposed to the print head to clean the print head. For example, web 304 may be lifted by cams 327 of service module receiver 328 such that the print head may be wiped across web 304. Although only one cam 327 is shown in FIG. 3, service module receiver 328 can include a pair of cams connected by a shaft such that when the cams are rotated, web 304 can be lifted to allow the print head of the 3D printer to be cleaned by web 304.

In some examples, service module receiver 328 can include a clamp. The clamp can mechanically attach service module 300 to service module receiver 328. For example, service module receiver 328 can receive service module 300, and the clamp included in service module receiver 328 can mechanically attach service module 300 to service module receiver 328.

In some examples, housing 302 can include a clamp. Similar to the example above, the clamp can mechanically attach service module 300 to service module receiver 328. For example, service module receiver 328 can receive service module 300, and the clamp included in housing 302 of the service module 300 can mechanically attach service module 300 to service module receiver 328.

Service module 300 can be removable from service module receiver 328. For example, service module 300 can be removed from service module receiver 328 by disengaging a clamp included in service module receiver 328 or included in housing 302 of service module 300, as described above. With the clamp disengaged, service module 300 may no longer be mechanically attached to service module receiver 328. Handle 314 may be used by a user to pull service module 300 from service module receiver 328 in a translational motion.

System 326 can include capping gimbal plate module 320. Capping gimbal plate module 320 can include cap 324 to receive a print head of the 3D printer. As described in connection with FIG. 2, cap 324 can be an elastomeric material that can be pressed against the print head of the 3D printer to seal nozzles of the print head when the print head is not in use. Cap 324 can prevent the nozzles of the print head from drying.

Capping gimbal plate module 320 can be removably attached to service module receiver 328. Capping gimbal plate module 320 can include posts 323 that can secure capping gimbal plate module 320 to service module receiver 328. Service module receiver 328 can include slots that can receive posts 323 to secure capping gimbal plate module 320 to service module receiver 328.

Capping gimbal plate module 320 can be removable from service module receiver 328. For example, capping gimbal plate module 320 can be removed from service module receiver 328 by rotating capping gimbal plate module 320 and translating capping gimbal plate module 320 away from service module receiver 328, as is further described in connection with FIG. 4. The rotational and/or translational motion can allow posts 323 of capping gimbal plate module 320 to slide out of the slots of the service module receiver 328, allowing capping gimbal plate module 320 to be removed from service module receiver 328.

Service module 300 can be electrically connected to service module receiver 328 via a mechanical make-break connection. As used herein, the term “mechanical make-break connection” can, for example, refer to an electrical connection between two parts facilitated by a mechanical fit between the two parts. The mechanical make-break connection can facilitate an electrical connection between service module 300 and service module receiver 328 such that service module 300 is electrically connected to the 3D printer.

Modules of a 3D printer can, for example, allow a user to easily remove and clean various components of the 3D printer. The user can remove the capping gimbal plate module from the service module receiver and clean the capping gimbal plate module without risk of damaging the web or web tensioning mechanisms included in the service module. The user can further remove the service module from the service module receiver for cleaning of various service module receiver hardware beneath the service module. The service module can be replaced when, for instance, the supply of clean web has been used up. Replacement of the service module when the web has been used up can prevent a user from having to route new web through the 3D printer, which can save the user cost, mess, hassle, and reduce 3D printer downtime.

FIG. 4 illustrates an example of a capping gimbal plate module removal 430 consistent with the disclosure. As shown in FIG. 4, a capping gimbal plate module 420 may be removed from a service module receiver 428.

Capping gimbal plate module 420 may be removable from service module receiver 428. For example, capping gimbal plate module 420 can be removed from service module receiver 428 by rotation and translation, as is further described herein.

Capping gimbal plate module 420 may be removed from service module receiver 428 by pivoting capping gimbal plate module 420 about axis 432. Axis 432 can be an axis following the geometry of a first post 423-1 of capping gimbal plate module 420. Capping gimbal plate module 420 may be pivoted about axis 432 in the direction shown in FIG. 4, which can raise a second post 423-2 from second slot 434-2 of service module receiver 428.

Removing capping gimbal plate module 420 from service module receiver 428 can include translating capping gimbal plate module 420 away from service module receiver 428 in the direction shown in FIG. 4. For example, capping gimbal plate module 420 can be moved in a translational motion such that first post 423-1 can clear first slot 434-1 of service module receiver 428.

Although not shown in FIG. 4 for clarity and so as not to obscure examples of the disclosure, in some examples, capping gimbal plate module 420 can be mechanically attached to and removably attached from service module 400. For example, service module 400 can include slots similar to slots 434-1 and 434-2, where capping gimbal plate module 420 can be mechanically attached to service module 400 via posts 423-1 and 423-2. Capping gimbal plate module 420 may be pivoted about axis 432 in the direction shown in FIG. 4, which can raise second post 423-2 from a second slot of service module 400. Capping gimbal plate module 420 may be translated away from service module 400 such that first post 423-1 can clear a first slow of service module 400.

Although capping gimbal plate module 420 is described above as being mechanically attached to and removably attached from service module receiver 428, examples of the disclosure are not so limited. For example, capping gimbal plate module 420 can be mechanically attached to and removably attached from service module 400, and service module 400 and capping gimbal plate module 420 can be removed from service module receiver 428 simultaneously.

FIG. 5 illustrates an example of a system 536 of 3D printer modules consistent with the disclosure. As shown in FIG. 5, the system 536 can include a service module 500, a web 504, a clamp 506, a handle 514, a service module receiver 528, a clean portion 538 of web 504, and a dirty portion 540 of web 504.

As described in connection with FIG. 1, web 504 can be exposed to clean a print head of the 3D printer during a print operation. For example, web 504 may be advanced from a clean roll through service module 500 such that clean portion 538 of web 504 may be exposed to the print head, where the print head may be moved across the clean portion 538 of web 504 to clean the print head. Web 504 can be advanced through service module 500 such that dirty portion 540 of web 504 can be advanced through service module 500 to be rolled up in a take-up roll.

Service module 500 can be removable from service module receiver 528. For example, service module 500 can be removed from service module receiver 528 after a capping gimbal plate module is removed from service module receiver 528.

Service module 500 can be removable from service module receiver 528 by disengaging clamp 506. With clamp 506 disengaged, service module 500 may no longer be mechanically attached to service module receiver 528. Handle 514 may swung up and be used by a user to pull service module 500 from service module receiver 528 in a translational motion away from service module receiver 528.

As used herein, “logic” is an alternative or additional processing resource to perform a particular action and/or element described herein. Logic may include hardware. The hardware may include processing resources such as circuitry, which are distinct from machine readable instructions on a machine readable media. Further, as used herein, “a” or “a number of” something may refer to one or more such things. For example, “a number of widgets” may refer to one or more widgets.

The figures follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

The above specification, examples and data provide a description of the method and applications, and use of the system and method of the disclosure. Since many examples may be made without departing from the spirit and scope of the system of the disclosure, this specification merely sets forth some of the many possible example configurations and implementations.

What is claimed is:

1. A service module of a three-dimensional (3D) printer, comprising:
a housing;
a web to clean a print head of the 3D printer, wherein the web is housed by the housing of the service module, and wherein the service module is removably attached to the 3D printer; and
a shield to shield the web.

2. The service module of claim 1, wherein the service module includes a web advance drive housed by the housing to advance the web through the housing to provide a clean portion of the web to clean the print head of the 3D printer during a print operation.

3. The service module of claim 1, wherein the service module includes a spit roller drive to advance a spit roller housed by the housing that receives a printing agent from the print head during a maintenance job.

4. The service module of claim 1, wherein the service module is removably attached to the 3D printer by a clamp.

5. The service module of claim 1, wherein the service module includes a handle to remove the service module from the 3D printer.

6. The service module of claim 1, wherein the service module includes an air duct to cool the print head.

7. The service module of claim 1, wherein the service module includes:
a first air duct to cool a color print head of the 3D printer; and
a second air duct to cool a black print head of the 3D printer.

8. A capping gimbal plate module of a three-dimensional (3D) printer, comprising:
a plate; and
a cap to receive a print head of the 3D printer, wherein the cap is connected to the plate;
wherein the capping gimbal plate module is removably attached to a service module receiver of the 3D printer.

9. The capping gimbal plate module of claim 8, wherein the capping gimbal plate module is removable from the service module receiver by:
pivoting the capping gimbal plate module about an axis; and
translating the capping gimbal plate module away from the service module receiver.

10. A system, comprising:
a service module receiver of a three-dimensional (3D) printer;
a service module of the 3D printer that is removably attached to the service module receiver of the 3D printer, wherein the service module includes:
a housing;
a web advance drive with a web, wherein the web and the web advance drive are housed by the housing; and
a spit roller drive with a spit roller, wherein the spit roller drive is housed by the housing; and
a capping gimbal plate module that is removably attached to the service module receiver of the 3D printer.

11. The system of claim 10, wherein the service module of the 3D printer further includes:
a clamp to mechanically attach the service module to the service module receiver;
a shield; and
a handle.

12. The system of claim 10, wherein the service module receiver of the 3D printer includes a clamp to mechanically attach the service module to the service module receiver.

13. The system of claim 10, wherein the capping gimbal plate module includes a cap to receive a print head of the 3D printer.

14. The system of claim 10, wherein:
the capping gimbal plate module is removable from the service module receiver; and
the service module is removable from the service module receiver.

15. The system of claim 10, wherein the service module is electrically connected to the service module receiver via a mechanical make-break connection.
